(19) United States
(12) Patent Application Publication
(10) Pub. No.: US 2013/0015267 A1
(43) Pub. Date: Jan. 17, 2013

(54) Portable pressurized water dispensing device

(71) Applicants: Cam Brensinger, Stratham, NH (US); Suzanne Turell, Nashua, NH (US)

(72) Inventors: Cam Brensinger, Stratham, NH (US); Suzanne Turell, Nashua, NH (US)

(73) Assignee: Nemo Equipment, Inc., Dover, NH (US)

(21) Appl. No.: 13/425,760

(22) Filed: Mar. 21, 2012

Related U.S. Application Data
(60) Provisional application No. 61/454,712, filed on Mar. 21, 2011.
(60) Provisional application No. 61/531,651, filed on Sep. 7, 2011.

(51) Int. Cl. B05B 9/04

(52) U.S. Cl. 239/373

(57) ABSTRACT

A portable pressurized water dispensing device or water supply device that includes a tank for holding water, a foot or hand operated pump for providing pressure and a water supply line with a water dispensing mechanism for dispensing pressurized water. The portable water dispensing device may also include a filter to create a potable water dispensing device.

### CROSS-REFERENCE TO RELATED APPLICATIONS

This application claims priority from U.S. Provisional Application Ser. No. 61/531,651 titled “Outdoor Equipment” which was filed on Sep. 7, 2011 and claims priority from U.S. Provisional Patent Application No. 61/454,712 titled “Outdoor Equipment” which was filed on Mar. 21, 2011, both of which are incorporated fully herein by reference.

### TECHNICAL FIELD

The present invention relates to a portable pressurized water dispensing device and a potable water dispensing device.

### BACKGROUND INFORMATION

Simple portable camping showers generally consist of a large bag that is black in color to facilitate heating the water using the sun. The bag is hung from an object, such as the top of a tent or a tree branch, above the user and a hose allows the water to drain using gravity to provide a shower. Owed to the density of water, these bags can be excessively heavy for many users to handle and finding a suitable location to hang the bag, which can support the weight of the bag, can be difficult in many situations. Other battery powered or propane powered options are too heavy for backpacking and inconvenient for many camping applications and are prohibitively expensive.

What is needed therefore is a simple design that allows a user to shower without the use of a battery and without the need to hang the bag of water above the user. The device should be usable as a portable showering device and also as a water dispensing device for any other purpose, such as hand washing or food preparation. The device should be simple to operate with a hand or foot and should utilize gravity to pressurize and to ease and simplify use of the water dispensing device.

Potable water is essential to people who are camping, hiking, and away from safe drinking water. Typically potable drinking water can be obtained through a canister or drinking apparatus, but the water is never pressurized and the quantities contained within the containers are limited. Additionally, many hand operated filters are difficult to operate and require significant exertion by a user. What is needed is a portable water dispensing device that allows a user to simply pressurize the water without the use of a battery in order to obtain potable water.

### SUMMARY OF THE INVENTION

The present invention features a compactable portable water dispensing device that comprises a flexible tank configured to hold water; an air supply line, connected to the tank via attachment means; a pump, connected to the air supply line, wherein the pump is configured to be operated by the foot or hand of a user, wherein said pump is configured to pressurize the water within the tank; a water supply line, connected to the tank; and a dispensing mechanism coupled to the water supply line, wherein the dispensing mechanism is configured to allow release of the pressurized water.

An alternate embodiment of the present invention features a water dispensing device for dispensing potable water, the water dispensing device comprising a flexible tank configured to hold water; an air supply line, connected to the tank via attachment means; a pump, connected to the air supply line, wherein the pump is configured to be operated by the hand or foot of a user, said pump configured to pressurize the water within the tank; a water supply line, connected to the tank; a water filtration device, located in-line of the water supply line, wherein the water filtration device filters the water, thereby creating potable water; and a dispensing mechanism coupled to the water supply line, wherein the dispensing mechanism is configured to allow release of the pressurized potable water.

It is important to note that the present invention is not intended to be limited to a system or method which must satisfy one or more of any stated objects or features of the invention. It is also important to note that the present invention is not limited to the preferred, exemplary, or primary embodiment(s) described herein. Modifications and substitutions by one of ordinary skill in the art are considered to be within the scope of the present invention.

### BRIEF DESCRIPTION OF THE DRAWINGS

These and other features and advantages of the present invention will be better understood by reading the following detailed description, taken together with the drawings wherein:

FIG. 1 is a detailed view of the pressurized water dispensing device of one embodiment of the present invention; and

FIG. 2 is a detailed cross-sectional view of the pump of one embodiment of the present invention.

### DETAILED DESCRIPTION OF THE PREFERRED EMBODIMENTS

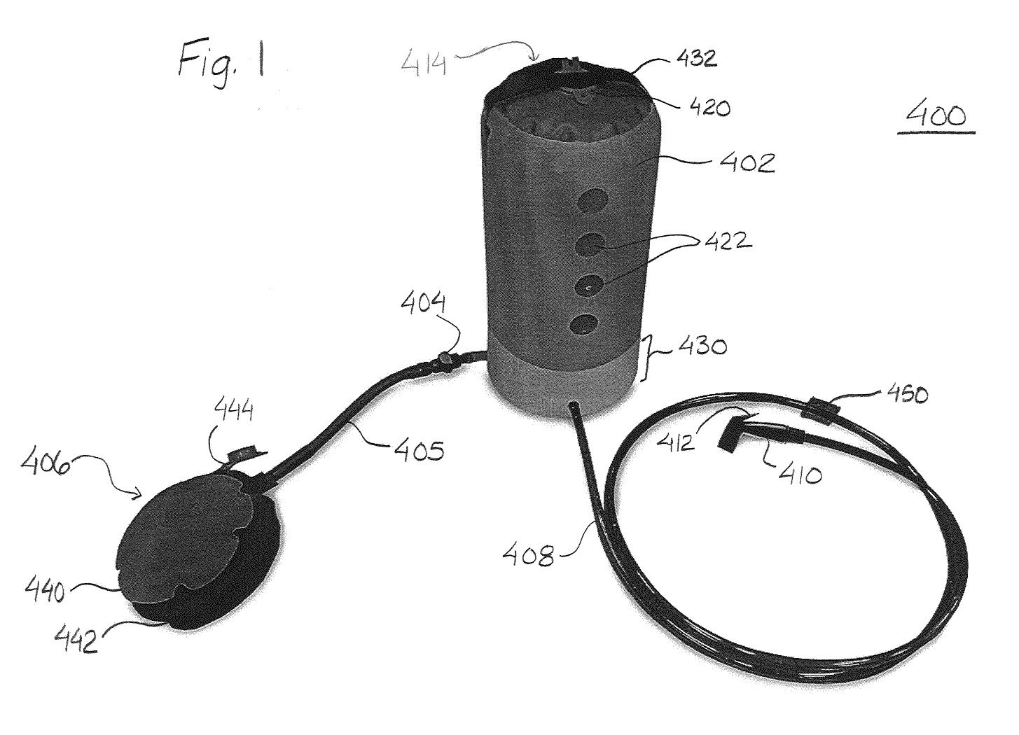

In another embodiment of the present invention, shown in FIG. 1, a portable water dispensing device 400 is provided. The portable water dispensing device 400 features a flexible tank 402, preferably made of a weldable coated fabric, which is configured to hold water. Water is added to the tank 402 through a fill cap 420, which is preferably located on a top surface 414. The tank 402 is preferably a dark color, such as black, to facilitate solar heating of the water held within the tank 402. The tank 402 may feature one or more clear windows 422 in order to facilitate a user viewing the amount of water remaining in the tank 402. The tank 402 is connected by attachment means 404 to an air supply line 405, which is connected to a pump 406. The pump 406 is preferably a simple pump operable by a user's hand or foot. The pump 406 is configured to provide pressurization to the water in the tank 402 when operated by the user. As the water in the tank 402 is pressurized, the water travels up a water supply line 408 to a dispensing mechanism 410. The dispensing mechanism 410, which may be a shower nozzle can be held in the hand of the user and turned on by squeezing a lever 412 on the dispensing mechanism 410. Alternatively, the dispensing mechanism 410 may be operated by any other conventional mechanism, such as a turn of the dispensing mechanism. The user manually operates the pump 406 with their hand or foot in order to create water pressure in the system and facilitate the release of water from the dispensing mechanism 410. The use of the pump with the tank enables gravity to assist in the liquid dispensing process.

When the user is done using the portable water dispensing device 400, the user simply stops operating the pump 406 and releases the pressure in the system by squeezing the lever 412 on the dispensing mechanism 410 and then dumping out any remaining water through the fill cap 420. Pressure from the system may also be relieved by removing the dispensing mechanism, or any other suitable method.

The portable water dispensing device 400 may also include other features. The tank 402 may feature a support base 430 found in a lower region of the tank 402. The support base 430 is preferably constructed from a firmer material, such as a plastic or composite, and serves to give the tank 402 additional support. The attachment means for the air supply line 405 and water supply line 408 may be found in the area of the support base 430. The attachment means may be found on the outside of the support base 430 and may then travel through the support base 430 to a location at a bottom surface of the tank 402. Attaching the water supply line and air supply line at the lower region of the tank 402 facilitates easy and complete draining of the water from the tank 402. The tank 402 may also feature a handle 432, which is preferably located on a top surface 414 of the tank 402 to facilitate carrying of the portable water dispensing device 400. The top surface 414 of the tank 402 may be clear in color in order to facilitate viewing the water level within the tank 402. The portable water dispensing device 400 is fully collapsible when not in use. The portable water dispensing device 400 is designed to be stored in a storage bag (not shown) that is essentially the same diameter and height as the support base 430.

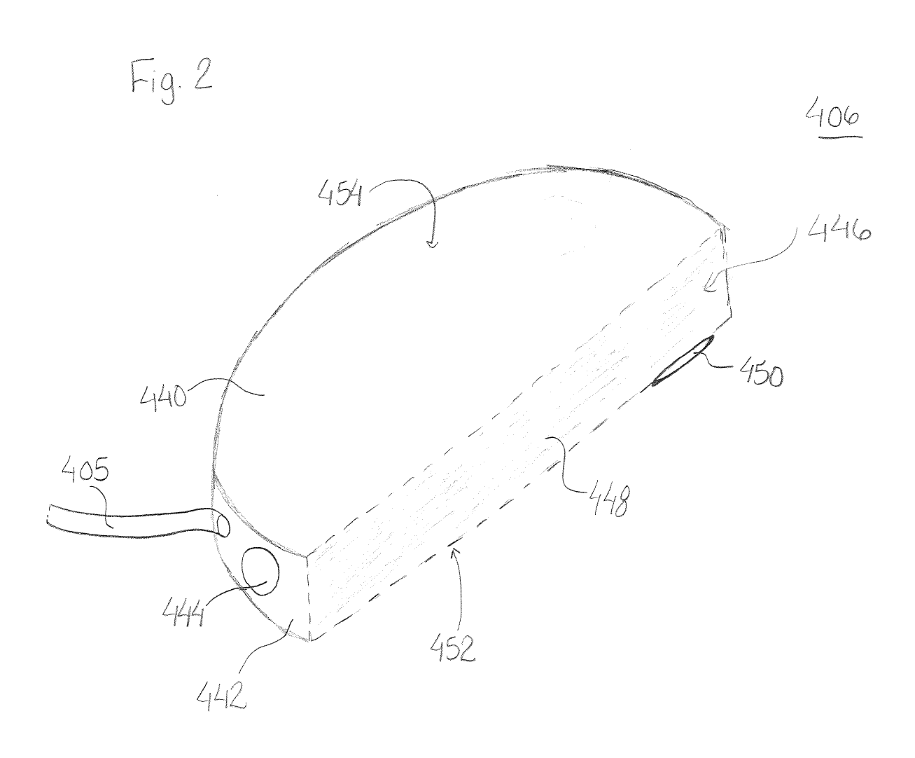

The pump 406, FIG. 2, is designed to be placed on the ground and operated by a user's foot or held in a user's hand and operated by a user's hand. The pump 406 may feature an upper portion 440 and a lower portion 442. The upper and lower portions 440/442 are welded together to create a single interior cavity 446. A user places their hand or foot on an upper surface 454 of the upper portion 440 to operate the pump. The interior cavity 446 of the pump 406 may include a return spring 448, preferably constructed from a mesh or foam material. The return spring 448 is configured to occupy a majority of the interior cavity 446 and serves two purposes. First, the return spring 448 gives the pump a shape or form that enables the pump to “bounce” back to shape after it has been pumped (stepped on). Second, the return spring 448 also serves as a filter to prevent dirt, debris, or other materials from entering the pump 406 and traveling up the air supply line 405 to the tank 402. The pump 406 features an air inlet 450 on a bottom surface 452 of the lower portion 442 and also features an air cap 444 on the lower portion 442. The air inlet 450 features one or more openings to allow air to travel into the pump 406 and through the filter, before being pumped into the air supply line 405. The air cap 444, when in an open state, allows a user to empty any trapped debris or dirt from the pump and also allows a user to fully deflate the pump for storage.

In another embodiment of the present invention, the portable water dispensing device 400 may also be utilized as and include a water filtration device 450. The water filtration device 450 is preferably located in-line at any location within the water supply line 408. The water filtration device 450 enables the pump 406 and tank 402 to dispense potable water. In this embodiment, the dispensing mechanism 410 may be replaced with a different type of nozzle or water dispensing device to provide controlled release of the potable water. The water filtration device 450 is preferably very light weight and can be of any type typically used and well known as water filtration elements that would be capable of filtering and removing one or more of the following: bacteria, protozoa, volatile organic compounds, pesticides, or any other sediment or contaminant. The water filtration device may be any commercially available water filter such as the Sawyer™ 3-way inline filter.

It is also contemplated and within the scope of the present invention that a purifying agent, such as a proper amount of bleach, may be added to the tank in order to maintain water suitable for cleaning and sanitizing.

Modifications and substitutions by one of ordinary skill in the art are considered to be within the scope of the present invention, which is not to be limited except by the following claims.

1. A compactable portable water dispensing device comprising:
a flexible tank configured to hold water;
an air supply line, connected to said tank via attachment means;
a pump, connected to said air supply line, wherein said pump is configured to be operated by the user, wherein said pump is configured to pressurize said water within said tank;
a water supply line, connected to said tank; and
dispensing mechanism coupled to said water supply line, wherein said dispensing mechanism is configured to allow controlled release of said pressurized water.

2. The device of claim 1, wherein said flexible tank is constructed from a weldable coated fabric.

3. The device of claim 1, wherein water is added to said flexible tank through a fill cap located on a top surface of said tank.

4. The device of claim 1, wherein said tank is a dark color thereby allowing solar heating of water held within said tank.

5. The device of claim 1, wherein said tank features one or more clear panels.

6. The device of claim 1, further comprising a support base located in a lower region of said tank, wherein said support base is constructed from a material that is firmer than a material of said tank.

7. The device of claim 6, wherein said attachment means for said air supply line and said water supply line pass through said support base.

8. The device of claim 1, wherein said pump comprises:
an upper portion and a lower portion, wherein said upper and lower portions are welded together to create a single interior cavity, wherein said interior cavity includes a return spring constructed from a mesh or foam material.

9. The device of claim 8, wherein said pump features an air inlet on a bottom surface of the lower portion and an air cap on the lower portion, wherein said air cap is configured to connect to said air supply line.

10. The device of claim 9, wherein said air inlet features one or more openings to allow air to travel into said pump and through said return spring, before being pumped into said air supply line, wherein said return spring is configured to filter said air traveling into said pump.

11. The device of claim 1, further comprising a water filtration device, wherein said water filtration device is located along the water supply line.

12. A water dispensing device for dispensing potable water, said water dispensing device comprising:
a flexible tank configured to hold water;
an air supply line, connected to said tank via attachment means;
a pump, connected to said air supply line, wherein said pump is configured to be operated by the foot of a user, wherein said pump is configured to pressurize said water within said tank;
a water supply line, connected to said tank;
a water filtration device, located in-line of said water supply line, wherein said water filtration device filters said water, thereby creating potable water; and
a dispensing device coupled to said water supply line, wherein said dispensing device is configured to allow controlled release of said pressurized potable water.

13. The device of claim 1, where said water dispensing device is a portable shower device.
